(19) United States
(12) Patent Application Publication
(10) Pub. No.: US 2014/0050387 A1
(43) Pub. Date: Feb. 20, 2014

(54) System and Method for Machine Vision Inspection

(71) Applicant: Ali M. Zadeh, Hopkinton, MA (US)

(72) Inventor: Ali M. Zadeh, Hopkinton, MA (US)

(73) Assignee: COGNEX CORPORATION, Natick, MA (US)

(21) Appl. No.: 13/588,868

(22) Filed: Aug. 17, 2012

(51) Int. Cl. G06K 9/00

(52) U.S. Cl. 382/141

(57) ABSTRACT

A computer-implemented method for use in machine vision systems is provided. The method can include receiving a source image and segmenting the source image into one or more segments. The method can further include receiving a selection of a first segment of the one or more segments associated with the source image and generating a first mask image, based upon, at least in part, the first segment. The method can also include determining at least one attribute associated with the first segment and normalizing a masked area of a runtime image using, at least in part, the at least one attribute.

### TECHNICAL FIELD

This technology relates to machine vision systems and methods, and more particularly to systems and methods for detecting flaws on parts and surfaces based upon trained images.

### BACKGROUND

Machine vision is used commonly to inspect manufactured objects, parts, printing and other physical items for visible flaws and defects. A variety of systems have been developed to perform such inspection, many of which contain a variety of advanced flaw-detection features and tools. One advanced inspection system is available under the Insight® product line from Cognex Corporation of Natick, Mass. Such systems can be trained with a model image of a desired part appearance, and employ advanced pattern recognition tools to compare the stored model image to the runtime image being inspected.

Two advanced software application are sold under the names PatMax® and Intellect®, and are also available from Cognex Corporation. These applications can utilize advanced techniques to register a runtime image with respect the trained image (if possible) even if the viewing angle is skewed, the part is rotated and the scale differs with respect to the training image. These applications can also allow the user to employ a variety of tools to aid in edge detection and other image-analysis processes.

### SUMMARY OF DISCLOSURE

In one implementation, a computer-implemented method for use in machine vision systems is provided. The method can include receiving a source image and segmenting the source image into one or more segments. The method can further include receiving a selection of a first segment of the one or more segments associated with the source image and generating a first mask image, based upon, at least in part, the first segment. The method can also include determining at least one attribute associated with the first segment and normalizing a masked area of a runtime image using, at least in part, the at least one attribute.

One or more of the following features can be included. In some embodiments, the method can include associating the at least one attribute with the first mask image. In some embodiments, the at least one attribute can be an average color. In some embodiments, the at least one attribute can be an intensity. The method can further include selecting a second associated with the source image. The method can also include generating a second mask image, based upon, at least in part, the second segment. The method can further include determining at least one attribute associated with the second segment. The method can also include normalizing a masked area of a runtime image using, at least in part, the at least one attribute associated with the second segment, wherein the second segment corresponds to a different portion of the source image than the first segment. The method can additionally include utilizing the first mask image with a device associated with a machine vision system.

In another implementation, a computer program product residing on a computer readable storage medium is provided. The computer program product can have a plurality of instructions stored thereon, which when executed by a processor, cause the processor to perform operations. Operations can include receiving a source image and segmenting the source image into one or more segments. Operations can further include receiving a selection of a first segment of the one or more segments associated with the source image and generating a first mask image, based upon, at least in part, the first segment. Operations can also include determining at least one attribute associated with the first segment and normalizing a masked area of a runtime image using, at least in part, the at least one attribute.

One or more of the following features can be included. In some embodiments, operations can include associating the at least one attribute with the first mask image. In some embodiments, the at least one attribute can be an average color. In some embodiments, the at least one attribute can be an intensity. Operations can further include selecting a second segment of the one or more segments associated with the source image. Operations can also include generating a second mask image, based upon, at least in part, the second segment. Operations can further include determining at least one attribute associated with the second segment. Operations can also include normalizing a masked area of a runtime image using, at least in part, the at least one attribute associated with the second segment, wherein the second segment corresponds to a different portion of the source image than the first segment. Operations can additionally include utilizing the first mask image with a device associated with a machine vision system.

In another implementation, a computing system having one or more processors is provided. The one or more processors can be configured to receive a source image. The one or more processors can be further configured to segment the source image into one or more segments. The one or more processors can be further configured to receive a selection of a first segment of the one or more segments associated with the source image. The one or more processors can be further configured to generate a first mask image, based upon, at least in part, the first segment. The one or more processors can be further configured to determine at least one attribute associated with the first segment. The one or more processors can be further configured to normalize a masked area of a runtime image using, at least in part, the at least one attribute.

One or more of the following features can be included. In some embodiments, the one or more processors can be further configured to associate the at least one attribute with the first mask image.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an imaging process coupled to a distributed computing network;

FIG. 2 is a system diagram corresponding to an embodiment of the imaging process of FIG. 1;

FIG. 3 is a flowchart of the imaging process of FIG. 1;

FIG. 4 is a diagrammatic view of an image associated with an embodiment of the imaging process of FIG. 1;

FIG. 5 is a graphical user interface associated with an embodiment of the imaging process of FIG. 1;

FIG. 6 is a graphical user interface associated with an embodiment of the imaging process of FIG. 1;

FIG. 7 is a diagrammatic view of an image associated with an embodiment of the imaging process of FIG. 1;

FIG. 8 is a diagrammatic view of an image associated with an embodiment of the imaging process of FIG. 1;

FIG. 9 is a diagrammatic view of an image associated with an embodiment of the imaging process of FIG. 1;

FIG. 10 is a diagrammatic view of an image associated with an embodiment of the imaging process of FIG. 1;

FIG. 11 is a diagrammatic view of an image associated with an embodiment of the imaging process of FIG. 1;

FIG. 12 is a diagrammatic view of an image associated with an embodiment of the imaging process of FIG. 1;

FIG. 13 is a diagrammatic view of an image associated with an embodiment of the imaging process of FIG. 1;

FIG. 14 is a diagrammatic view of an image associated with an embodiment of the imaging process of FIG. 1; and

FIG. 15 is a diagrammatic view of an image associated with an embodiment of the imaging process of FIG. 1.

Like reference symbols in the various drawings can indicate like elements.

### DETAILED DESCRIPTION OF THE EMBODIMENTS

### System Overview:

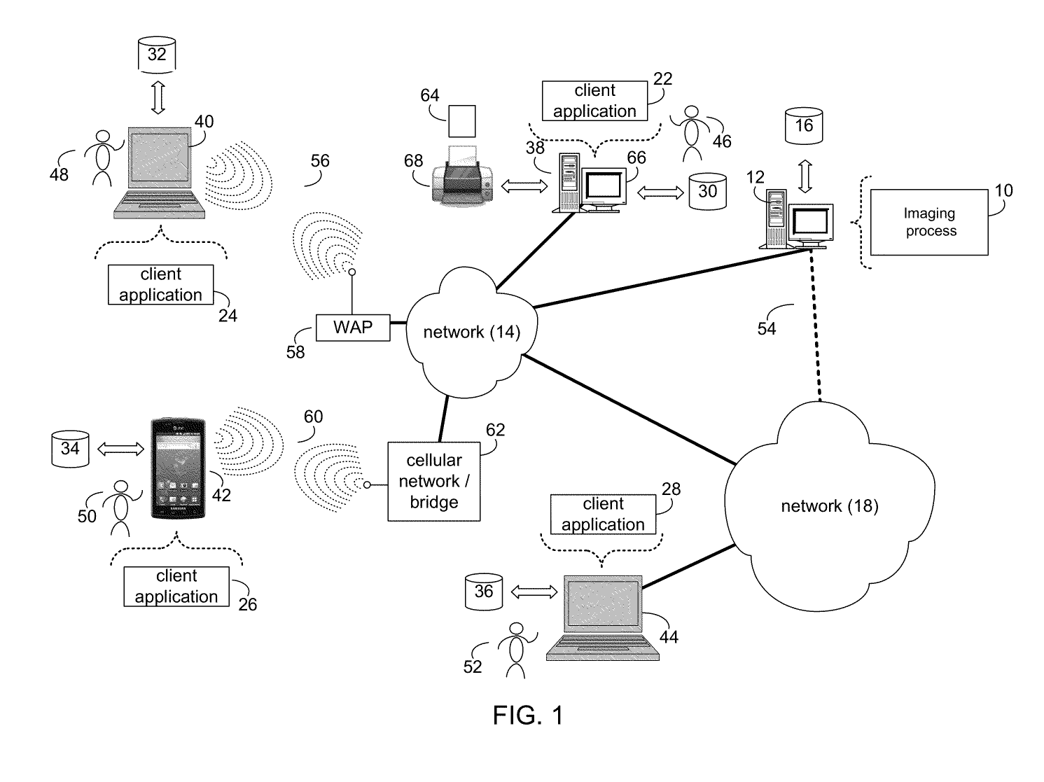

Referring to FIG. 1, there is shown imaging process 10 that can reside on and can be executed by computer 12, which can be connected to network 14 (e.g., the Internet or a local area network). Examples of computer 12 can include but are not limited to a single server computer, a series of server computers, a single personal computer, a series of personal computers, a mini computer, a mainframe computer, or a computing cloud. The various components of computer 12 can execute one or more operating systems, examples of which can include but are not limited to: Microsoft Windows Server™; Novell Netware™; Redhat Linux™, Unix, or a custom operating system, for example.

The instruction sets and subroutines of imaging process 10, which can be stored on storage device 16 coupled to computer 12, can be executed by one or more processors (not shown) and one or more memory architectures (not shown) included within computer 12. Storage device 16 can include but is not limited to: a hard disk drive; a flash drive, a tape drive; an optical drive; a RAID array; a random access memory (RAM); and a read-only memory (ROM).

Network 14 can be connected to one or more secondary networks (e.g., network 18), examples of which can include but are not limited to: a local area network; a wide area network; or an intranet, for example.

Imaging process 10 can be accessed via client applications 22, 24, 26, 28. Examples of client applications 22, 24, 26, 28 can include but are not limited to a standard web browser, a customized web browser, or a custom application. The instruction sets and subroutines of client applications 22, 24, 26, 28, which can be stored on storage devices 30, 32, 34, 36 (respectively) coupled to client electronic devices 38, 40, 42, 44 (respectively), can be executed by one or more processors (not shown) and one or more memory architectures (not shown) incorporated into client electronic devices 38, 40, 42, 44 (respectively).

Storage devices 30, 32, 34, 36 can include but are not limited to: hard disk drives; flash drives, tape drives; optical drives; RAID arrays; random access memories (RAM); and read-only memories (ROM). Examples of client electronic devices 38, 40, 42, 44 can include, but are not limited to, personal computer 38, laptop computer 40, smart phone 42, notebook computer 44, a server (not shown), a data-enabled, cellular telephone (not shown), and a dedicated network device (not shown).

One or more of client applications 22, 24, 26, 28 can be configured to effectuate some or all of the functionality of imaging process 10. Accordingly, imaging process 10 can be a purely server-side application, a purely client-side application, or a hybrid server-side / client-side application that is cooperatively executed by one or more of client applications 22, 24, 26, 28 and imaging process 10.

Users 46, 48, 50, 52 can access computer 12 and imaging process 10 directly through network 14 or through secondary network 18. Further, computer 12 can be connected to network 14 through secondary network 18, as illustrated with phantom link line 54.

The various client electronic devices can be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 can be, for example, an IEEE 802.11a, 802.11b, 802.11g, Wi-Fi, and/or Bluetooth device that is capable of establishing wireless communication channel 56 between laptop computer 40 and WAP 58. Smart phone 42 is shown wirelessly coupled to network 14 via wireless communication channel 60 established between smart phone 42 and cellular network/bridge 62, which is shown directly coupled to network 14.

As is known in the art, all of the IEEE 802.11x specifications can use Ethernet protocol and carrier sense multiple access with collision avoidance (i.e., CSMA/CA) for path sharing. The various 802.11x specifications can use phase-shift keying (i.e., PSK) modulation or complementary code keying (i.e., CCK) modulation, for example. As is known in the art, Bluetooth is a telecommunications industry specification that allows e.g., mobile phones, computers, and smart phones to be interconnected using a short-range wireless connection.

Client electronic devices 38, 40, 42, 44 can each execute an operating system, examples of which can include but are not limited to Apple iOS™, Microsoft Windows™, Android™, Redhat Linux™, or a custom operating system.

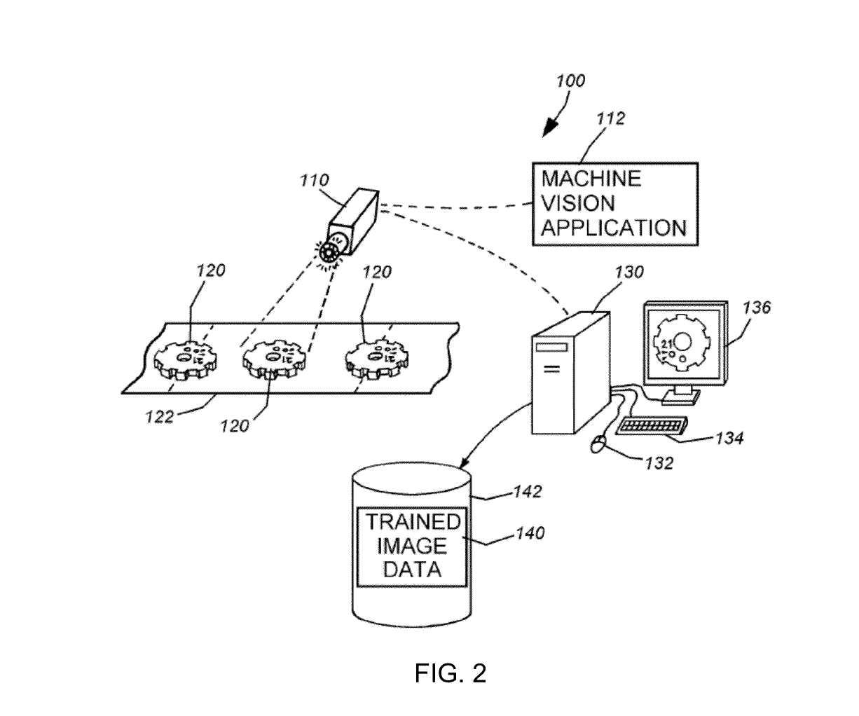

Referring now to FIG. 2, an exemplary embodiment depicting a machine vision system 100 configured for use with imaging process 10 is provided. It should be noted that a variety of system implementations can be employed in alternate embodiments without departing from the scope of the present disclosure. For example, a machine vision detector system in accordance with commonly assigned, co-pending U.S. Published Patent Application No. US200550275831A1, entitled METHOD AND APPARATUS FOR VISUAL DETECTION AND INSPECTION OF OBJECTS, by William M. Silver (the teachings of which are expressly incorporated by reference), can be employed in an alternate embodiment. As will be described in further detail below, embodiments of imaging process 10 described herein can be generally employed, inter alia, to automatically generate a custom mask image based upon a segmented source image and to normalize the masked area of a runtime image. The imaging process described herein can be used at any suitable time during the inspection process. For example, in some embodiments, aspects of the imaging process can occur subsequent to the global positioning/registration of a live or runtime object image relative to a model or training image of the object, and prior to, during, or after inspection of the runtime object or feature.

In some embodiments, machine vision system 100 can include an imaging device 110, which can be a camera that includes an onboard processor (not shown) and a memory (not shown) capable of running a machine vision application 112. Appropriate interfaces, alarms, and signals can be installed in, and/or connected to, camera imaging device 110 so that it is able to respond to a sensed fault detected during the inspection of an underlying object 120. In this embodiment, a conveyor 122 containing a plurality of objects (120) is shown. These objects can pass, in turn, within the predetermined field of view (FOV) of the imaging device 110, so that their runtime images can be acquired and inspected for flaws (and/or other features of interest) during an inspection process. As such, the imaging device 110 can acquire at least one image of each observed object 120.

In some embodiments, conventional microcomputer 130 can be any suitable computing device such as computer 12 shown in FIG. 1. Computer 130 can include graphical user interface components, such as a mouse 132, keyboard 134 and display 136. Other types of interfaces can also be employed, such as a Personal Digital Assistant (PDA) in alternate embodiments. In some embodiments, the imaging device 110 can be connected full-time to the computer 130, particularly where the computer performs the image processing functions. Additionally and/or alternatively, the processor in imaging devices, such as those of the Insight® product line, can allow for independent operation of the device free interconnection with a remote computer. In this embodiment, computer 130 can be connected to, and/or communicates with, the imaging device 110 for device-setup, testing, and analysis of runtime operation.

In some embodiments, data related to a model or training image 140 can be stored in connection with the computer 130 in disc storage 142, and can be stored in the onboard memory of the imaging device 110. This data can include data associated with imaging process 10, which can be employed according to one or more embodiments of the present disclosure.

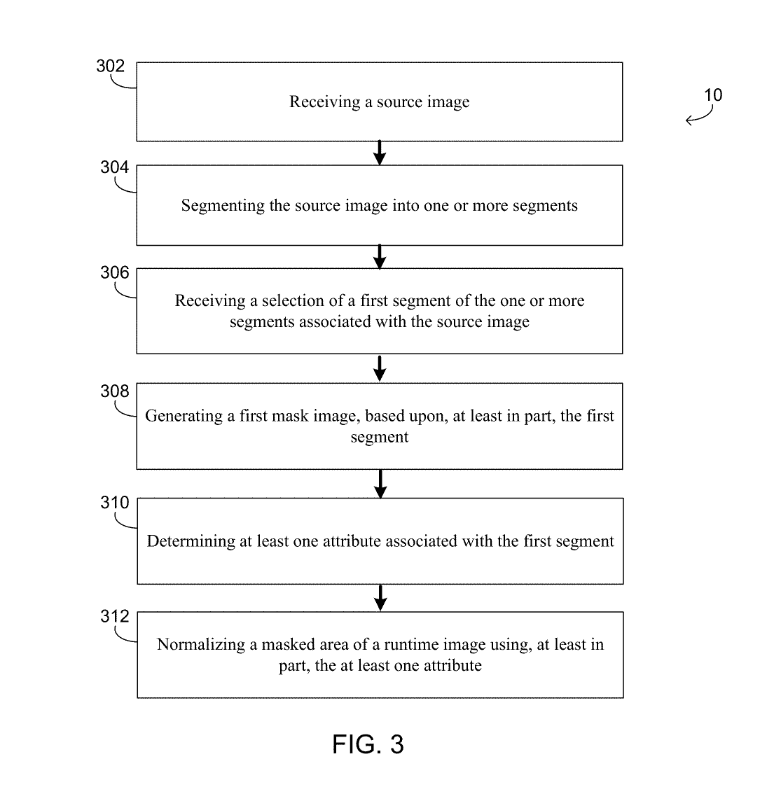

Referring also to FIG. 3, and as will be discussed below in greater detail, imaging process 10 can include receiving (302) a source image and segmenting (304) the source image into one or more segments. The method can further include selecting (306) a first segment of the one or more segments associated with the source image and generating (308) a first mask image, based upon, at least in part, the first segment. The method can also include determining (310) at least one attribute associated with the first segment and normalizing (312) a masked area of a runtime image using, at least in part, the at least one attribute.

Embodiments disclosed herein are directed towards a computer-implemented method for machine vision inspection. In some embodiments, imaging process 10 can be configured to address issues involving irregular inspection regions and can allow for extraction of certain regions for inspection. In some cases, the intensity and/or color of the main inspection region can change from one image to another, imaging process 10 can be configured to correct for this variation and allow for the detection of small defects. In some embodiments, imaging process 10 can be configured to output a fixtured custom mask image, and/or normalize an input image in certain areas. A custom mask image can be automatically and easily generated from the source image at train time. Accordingly, the trained mask image can be fixtured to be used for inspection tools. Additionally and/or alternatively, the input image can be normalized within the fixtured custom masked region.

In some embodiments, the source image can be first segmented and different segments can be extracted and indexed. One or multiple segments can be selected and a mask image can be generated based on the one or more selected segments. The average color and/or intensity of the one or more selected segments can then be computed and saved with the mask image. This information can be used to normalize the masked area of a runtime image. Embodiments of the present disclosure can support both grey scale and color images.

Embodiments of the imaging process described herein can be used to normalize the color of a section of an image. The irregular shape of various section of an image can make it difficult for a user to choose a section and only work in that region. Imaging process 10 allows a user to select a desired region of an image and can also be used to normalize the image within the selected region.

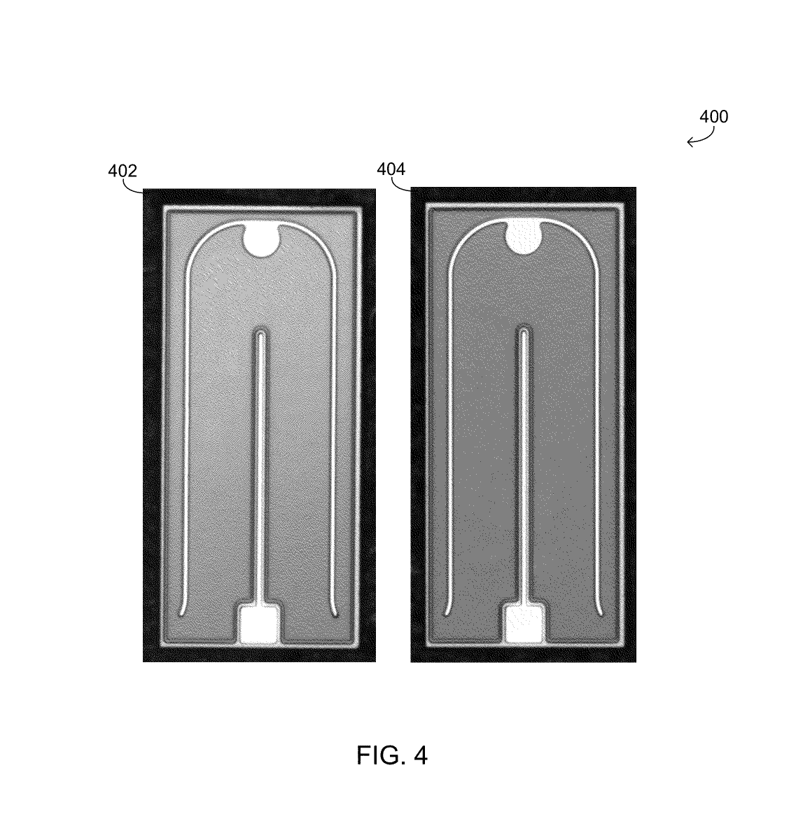

Referring now to FIG. 4, two images 402, 404 depicting a light-emitting diode (“LED”) are provided. In this particular example each image has different colors in the main surface. Accordingly, imaging process 10 can allow for the normalization of the color of the main surface to match the other image. In some embodiments, this can occur prior to pixel to pixel comparison for detecting defects.

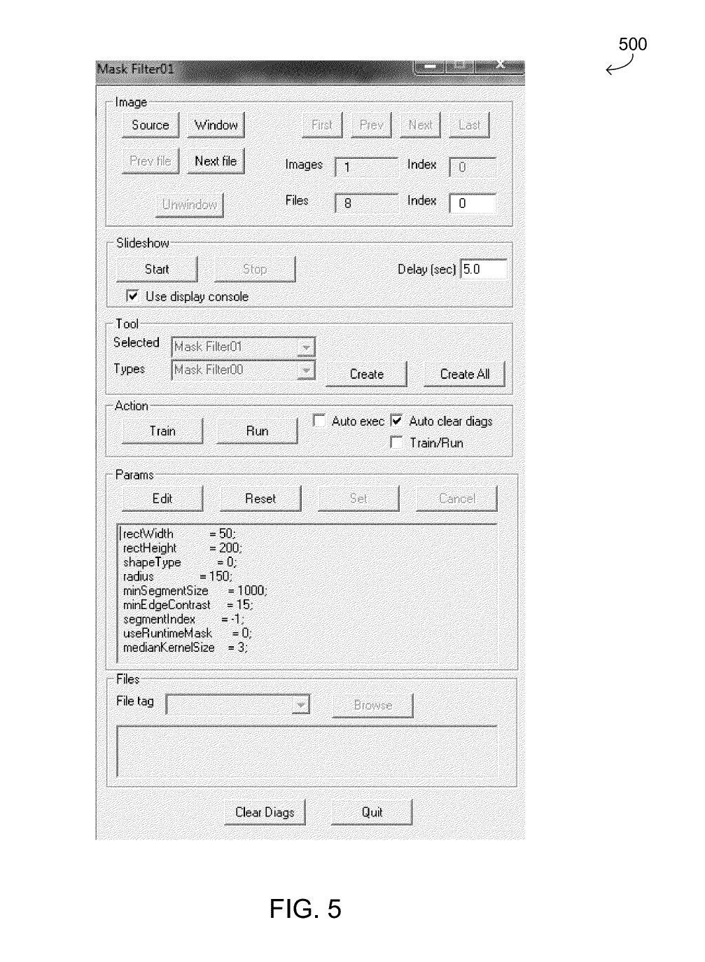

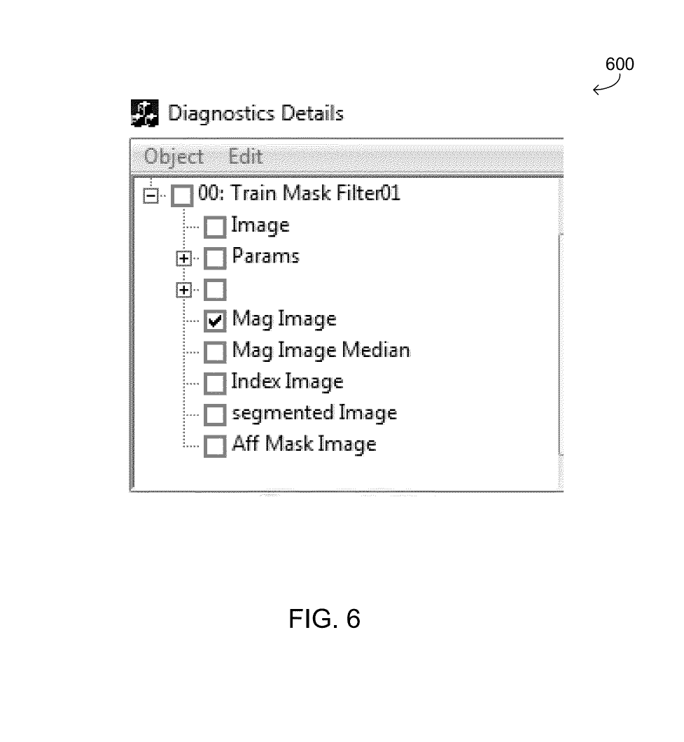

Referring now to FIG. 5, exemplary embodiments of graphical user interfaces 500 and 600, which can be used in accordance with imaging process 10 are provided. Accordingly, user interface 500 can be configured to allow a user to set one or more parameters associated with imaging process 10. In this way, a user can select one or more images (e.g. a source image) and can select a particular action according to an editable set of parameters. FIG. 6 depicts one particular embodiment that can allow a user to select one or more outputs for display and diagnostics purposes.

In some embodiments, once a source image has been received (302), imaging process 10 can incorporate training of one or more images or segments of an image. Training of an image can include, but is not limited to, segmentation (304) of an image and segment selection for the mask image. Segmentation of an image can include determining a gradient magnitude image based upon, at least in part, the smoothed image. Smoothing the image can include, but is not limited to, numerous filtering techniques such as median filtering, etc. For color images, the gradient magnitude image can be computed on all three channels at first. The gradient magnitude at each pixel can then be computed to be the maximum of the three and then combined using the max( ) operator.

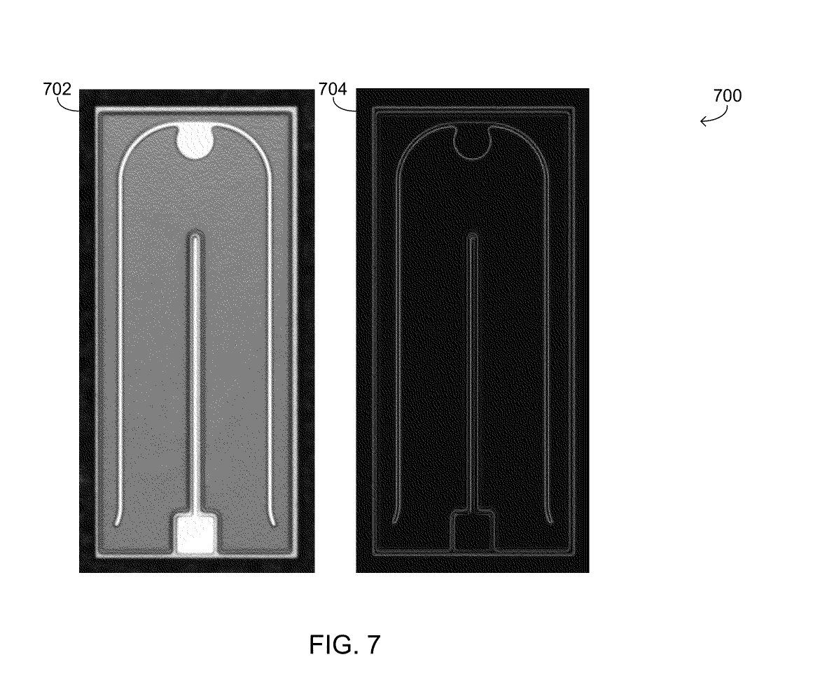

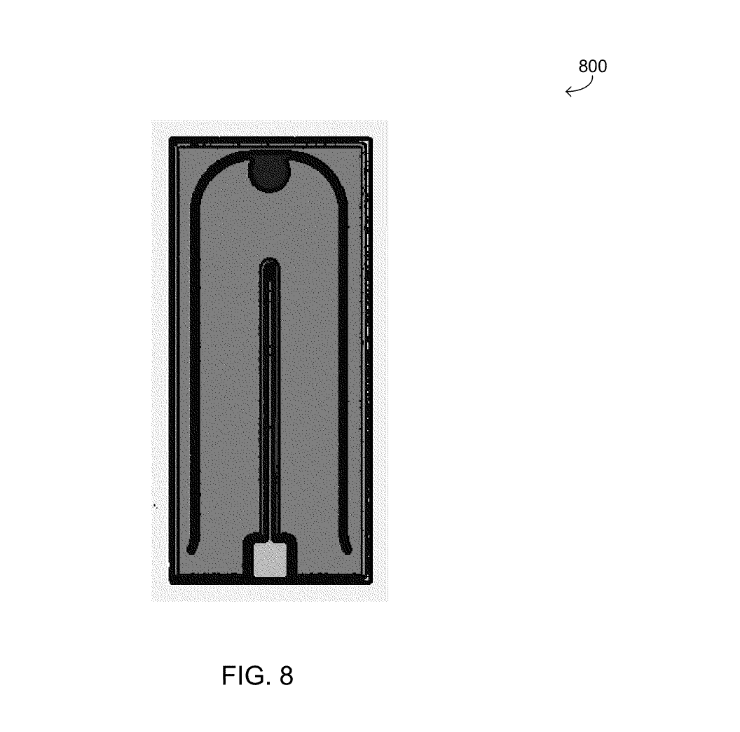

Referring now to FIG. 7, an exemplary embodiment depicting an example of both the smoothed image 702 and the gradient magnitude image 704 is provided. In some embodiments, different segments in the image can be separated by high gradient pixels. A blob function can be performed next on the gradient magnitude image and dark blobs (separated by edge pixels) can be extracted. The image depicted in FIG. 8 shows the index image of the found segments. In some embodiments, a different intensity value can be used to paint a segment for diagnostics and display purposes. In this particular example, eight segments are found. In this particular example, black pixels are part of no segments. Table 1 provided below shows the properties of each segment (i.e. segments 0-7). Each segment can include an index value, a drawing intensity value, an area value, and average rgb color values.

TABLE 1

0 −> 31, area = 3032, i = 0, r = 246, g = 246, b = 246
1 −> 62, area = 1000, i = 0, r = 97, g = 98, b = 82
2 −> 93, area = 1047, i = 0, r = 72, g = 68, b = 66
3 −> 124, area = 185028, i = 0, r = 182, g = 108, b = 81
4 −> 155, area = 3567, i = 0, r = 75, g = 76, b = 68
5 −> 186, area = 4399, i = 0, r = 247, g = 247, b = 247
6 −> 217, area = 1144, i = 0, r = 217, g = 210, b = 135
7 −> 248, area = 80829, i = 0, r = 14, g = 18, b = 31

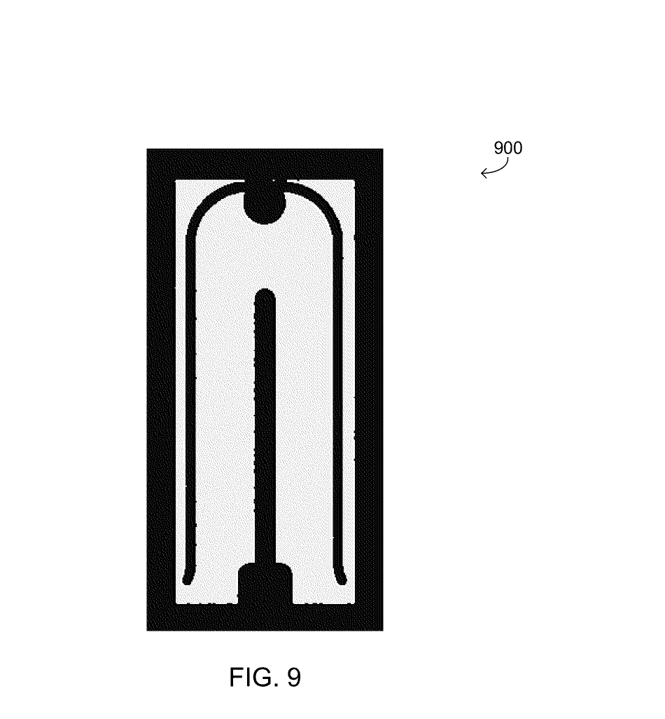

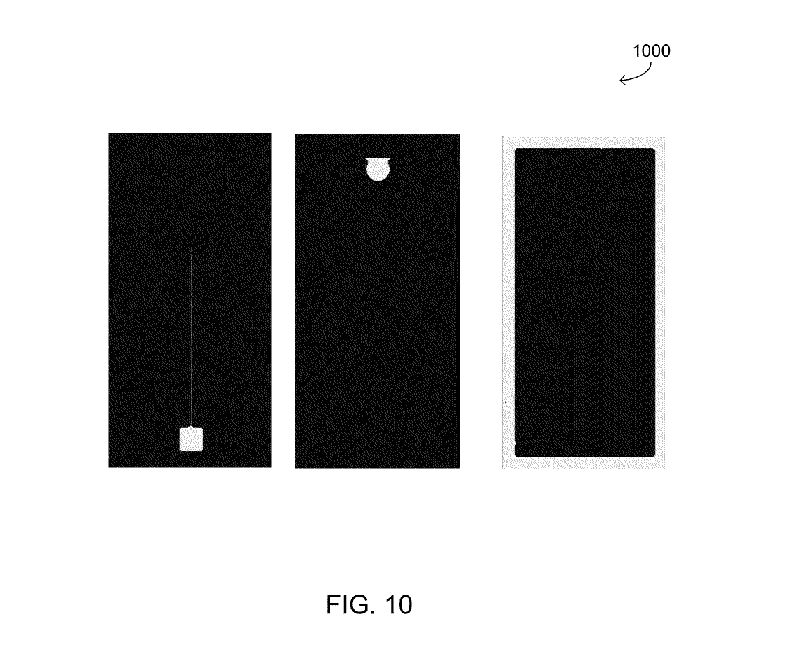

As discussed above, and referring now to FIG. 9, training of an image can also include segment selection (306) for the mask image. In some embodiments, image process 10 can include a default setting. In this particular example, the default can result in selection of the largest segment as shown in FIG. 9. In this particular example, the median filter can be used to fill the holes in the mask image, smooth the borders and remove narrow strips. The average color of the masked area can be computed and stored with the model at train time. Image process 10 can allow a user to select one or more segments for the mask image. FIG. 10 depicts examples of images that depict how the mask image can appear when a different segment is used for training Once the segments have been selected, imaging process 10 can be configured to generate (308) one or more mask images based upon the selected segment or segments.

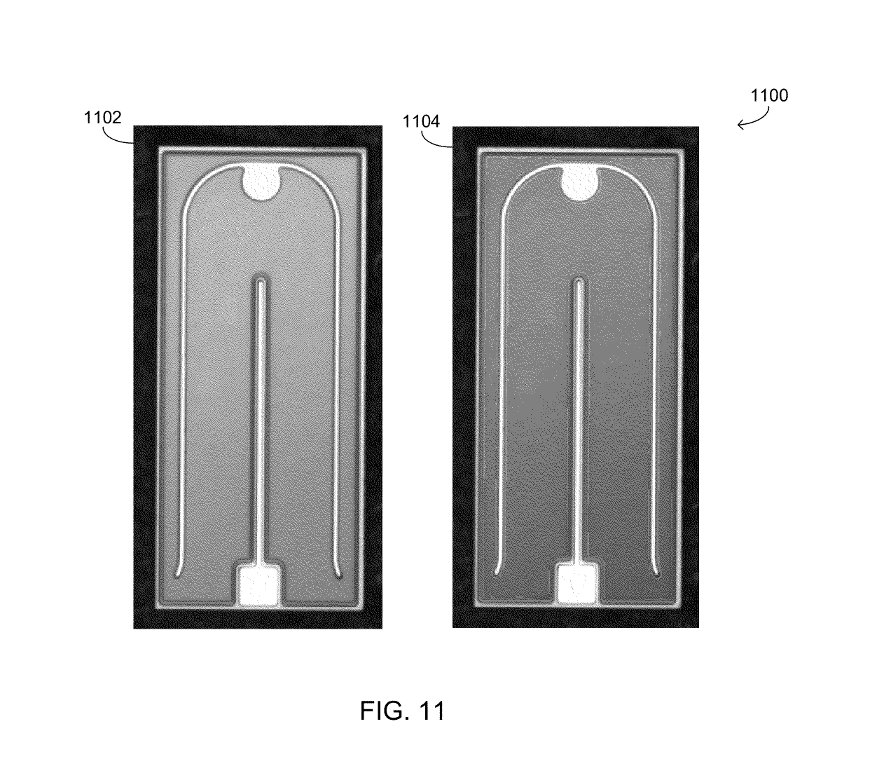

As discussed above, image process 10 can be configured to perform normalization (312) upon the masked image. Accordingly, in some embodiments, the mask image can be fixtured to the training image so that it is lined up with the runtime image. In this way, one or more attributes associated with the first segment and/or mask image can be determined (310). For example, the average color/intensity of the runtime image within the fixtured mask image can be determined and/or measured and a color/intensity offset compared to the trained color/intensity can be computed. The pixel data within the masked area of the image can then be adjusted by the computed offset resulting in a normalized image. FIG. 11 depicts one example of a runtime image 1102 and a masked normalized image 1104. The result image can be used for flexible flaw detection (“FFD”) or other tools.

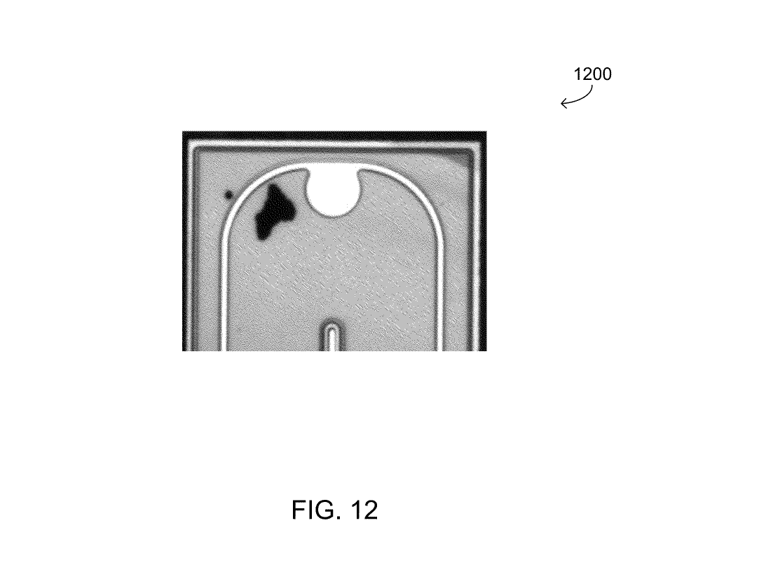

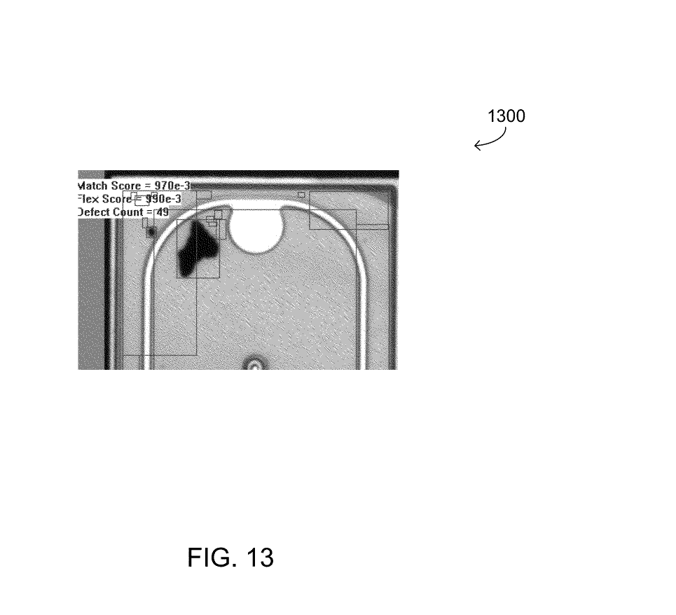

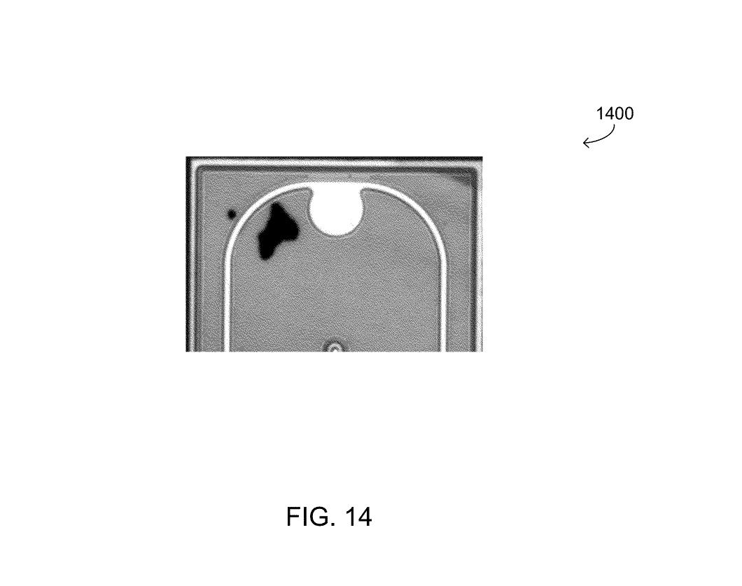

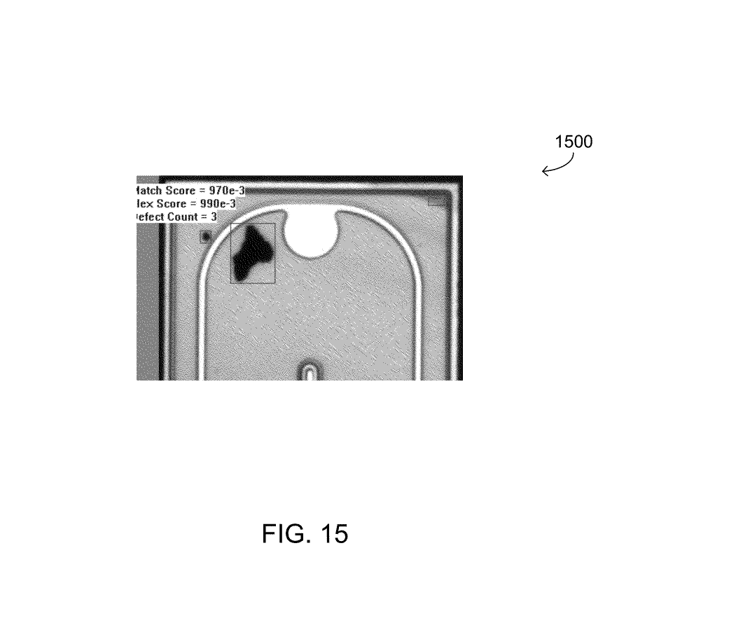

Referring now to FIGS. 12-15, embodiments depicting one particular application of imaging process 10 are provided. FIG. 12 depicts a section of a runtime image. In operation, and in accordance with imaging process 10, a flaw detection tool locates 49 defects in this image, if the image is not normalized within the main surface as is shown in FIG. 13. FIG. 14 depicts an example showing the normalized image when the mask filter is used and the image is normalized within the masked region. FIG. 15 shows the three identified defects, which can be located using any suitable approach (e.g. flaw detection tools, etc.).

As will be appreciated by one skilled in the art, the present disclosure can be embodied as a method, system, or computer program product. Accordingly, the present disclosure can take the form of an entirely hardware embodiment, an entirely software embodiment (including firmware, resident software, micro-code, etc.) or an embodiment combining software and hardware aspects that can all generally be referred to herein as a “circuit,” “module” or “system.” Furthermore, the present disclosure can take the form of a computer program product on a computer-usable storage medium having computer-usable program code embodied in the medium.

Any suitable computer usable or computer readable medium can be utilized. The computer-usable or computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium can be any medium that can contain, store, communicate, propagate, or transport the program for use by or in connection with the instruction execution system, apparatus, or device. The computer-usable medium can include a propagated data signal with the computer-usable program code embodied therewith, either in baseband or as part of a carrier wave. The computer usable program code can be transmitted using any appropriate medium, including but not limited to the Internet, wireline, optical fiber cable, RF, etc.

Computer program code for carrying out operations of the present disclosure can be written in an object oriented programming language such as Java, Smalltalk, C++ or the like. However, the computer program code for carrying out operations of the present disclosure can also be written in conventional procedural programming languages, such as the “C” programming language or similar programming languages. The program code can execute entirely on the user's computer, partly on the user's computer, as a stand-alone software package, partly on the user's computer and partly on a remote computer or entirely on the remote computer or server. In the latter scenario, the remote computer can be connected to the user's computer through a local area network (LAN) or a wide area network (WAN), or the connection can be made to an external computer (for example, through the Internet using an Internet Service Provider).

The present disclosure is described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions can also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

What is claimed is:

1. A computer-implemented method comprising:
receiving, at one or more computing devices, a source image;
segmenting, using the one or more computing devices, the source image into one or more segments;
receiving, using the one or more computing devices, a selection of a first segment of the one or more segments associated with the source image;
generating, using the one or more computing devices, a first mask image, based upon, at least in part, the first segment;
determining, using the one or more computing devices, at least one attribute associated with the first segment; and
normalizing, using the one or more computing devices, a masked area of a runtime image using, at least in part, the at least one attribute.

2. The computer-implemented method of claim 1, further comprising:
associating, using the one or more computing devices, the at least one attribute with the first mask image.

3. The computer-implemented method of claim 1, wherein the at least one attribute is an average color.

4. The computer-implemented method of claim 1, wherein the at least one attribute is an average intensity.

5. The computer-implemented method of claim 1, further comprising:
selecting, using the one or more computing devices, a second segment of the one or more segments associated with the source image.

6. The computer-implemented method of claim 5, further comprising:
generating, using the one or more computing devices, a second mask image, based upon, at least in part, the second segment.

7. The computer-implemented method of claim 6, further comprising:
determining, using the one or more computing devices, at least one attribute associated with the second segment.

8. The computer-implemented method of claim 7, further comprising:
normalizing, using the one or more computing devices, a masked area of a runtime image using, at least in part, the at least one attribute associated with the second segment, wherein the second segment corresponds to a different portion of the source image than the first segment.

9. The computer-implemented method of claim 1, further comprising:
utilizing, using the one or more computing devices, the first mask image with a device associated with a machine vision system.

10. A computer program product residing on a computer readable storage medium having a plurality of instructions stored thereon, which when executed by a processor, cause the processor to perform operations comprising:
receiving, at one or more computing devices, a source image;
segmenting, using the one or more computing devices, the source image into one or more segments;
receiving, using the one or more computing devices, a selection of a first segment of the one or more segments associated with the source image;
generating, using the one or more computing devices, a first mask image, based upon, at least in part, the first segment;
determining, using the one or more computing devices, at least one attribute associated with the first segment; and
normalizing, using the one or more computing devices, a masked area of a runtime image using, at least in part, the at least one attribute.

11. The computer program product of claim 10, wherein operations further comprise:
associating, using the one or more computing devices, the at least one attribute with the first mask image.

12. The computer program product of claim 10, wherein the at least one attribute is an average color.

13. The computer program product of claim 10, wherein the at least one attribute is an average intensity.

14. The computer program product of claim 10, wherein operations further comprise:
selecting, using the one or more computing devices, a second segment of the one or more segments associated with the source image.

15. The computer program product of claim 14, wherein operations further comprise:
generating, using the one or more computing devices, a second mask image, based upon, at least in part, the second segment.

16. The computer program product of claim 15, wherein operations further comprise:
determining, using the one or more computing devices, at least one attribute associated with the second segment.

17. The computer program product of claim 16, wherein operations further comprise:
normalizing, using the one or more computing devices, a masked area of a runtime image using, at least in part, the at least one attribute associated with the second segment, wherein the second segment corresponds to a different portion of the source image than the first segment.

18. The computer program product of claim 10, wherein operations further comprise:
utilizing, using the one or more computing devices, the first mask image with a device associated with a machine vision system.

19. A computing system comprising:
one or more processors configured to receive a source image, the one or more processors further configured to segment the source image into one or more segments, the one or more processors further configured to receive a selection of a first segment of the one or more segments associated with the source image, the one or more processors further configured to generate a first mask image, based upon, at least in part, the first segment, the one or more processors further configured to determine at least one attribute associated with the first segment, the one or more processors further configured to normalize a masked area of a runtime image using, at least in part, the at least one attribute.

20. The computing system of claim 19, wherein the one or more processors are further configured to associate the at least one attribute with the first mask image.
